(19) United States
(12) Patent Application Publication
(10) Pub. No.: US 2024/0403981 A1
(43) Pub. Date: Dec. 5, 2024

(54) Automated Title Transfer System

(71) Applicant: On Chain Listings, Inc., Lewes, DE (US)

(72) Inventors: Ori Ohayon, Toronto (CA); Tory Ricalis, Keswick (CA); Adam Yormack, Coral Gables, FL (US); Neel Kawale, Toronto (CA); Alex McCurry, Rincon (PR)

(73) Assignee: On Chain Listings, Inc., Lewes, DE (US)

(21) Appl. No.: 18/620,538

(22) Filed: Mar. 28, 2024

Related U.S. Application Data
(60) Provisional application No. 63/455,500, filed on Mar. 29, 2023.

(51) Int. Cl. G06Q 50/16; G06Q 30/0601

(52) U.S. Cl. CPC G06Q 50/16; G06Q 30/0637; G06Q 30/0641

(57) ABSTRACT

A property interactive system includes the seller to display seller added listings. The property interactive system further includes a review property module. The property interactive system further includes a buyer the ability for immediate purchase of a listing using an on-chain title, the seller inspects pending buyer offers through to either accept the pending offer or deny the pending offer.

### CROSS-REFERENCE TO RELATED APPLICATIONS

This claims priority under 35 U.S.C. § 119 to U.S. Provisional Application No. 63/455,500, filed Mar. 29, 2023.

### FIELD OF THE INVENTION

The present invention pertains to real estate and, more particularly, to an improved system of property title verification and transfer process for real estate.

### BACKGROUND

The invention of the property interactive system provides a solution for enhancing the efficiency of property transactions for real estate brokers, title lawyers, buyers, and sellers. This solution includes an API-based tool that seamlessly integrates with existing brokerage platforms, transforming real estate listings data into a set of blockchain protected smart contracts. The smart contracts verify the authenticity of the data against the relevant land registry and record the property listing onto the distributed ledger. This streamlined process significantly reduces the time and cost associated with title transfers for real-world properties.

Utilizing distributed ledger technology, the property interactive system provides a universal and immutable database for securing and protecting property ownership rights. Digitizing property titles enables faster title transfers, reduces transaction costs, and eliminates paper waste and inefficiencies, making property ownership accessible to more individuals. Furthermore, the transparency of the database enhances the protection of user data, eliminating the risk of title fraud.

### SUMMARY

A property interactive system includes a plurality of seller user functions, the plurality of seller user functions having an add property module, the add property module displays seller added listings. The property interactive system further includes a review property module. The property interactive system further includes a plurality of buyer user functions, the plurality of buyer user functions having a buy now module. The buy now module provides the buyer the ability for immediate purchase of a listing using an on-chain title. The seller inspects pending buyer offers through the review property module to either accept the pending offer or deny the pending offer.

### BRIEF DESCRIPTION OF DRAWINGS

In the following, the present invention is described in more detail with references to the drawings in which:

FIG. 1 illustrate a schematic diagram of hardware infrastructure for the property interactive system;

FIG. 2 illustrates an isolated schematic diagram of a portion of a global flow chart of the implementation of the system;

FIG. 3A illustrates another isolated schematic diagram of a portion of a global flow chart of the implementation of the system;

FIG. 3B illustrates another isolated schematic diagram of a portion of a global flow chart of the implementation of the system;

FIG. 3C illustrates another isolated schematic diagram of a portion of a global flow chart of the implementation of the system;

FIG. 4 illustrates another isolated schematic diagram of a portion of a global flow chart of the implementation of the system;

FIG. 5 illustrates another isolated schematic diagram of a portion of a global flow chart of the implementation of the system;

FIG. 6A illustrates another isolated schematic diagram of a portion of a global flow chart of the implementation of the system;

FIG. 6B illustrates another isolated schematic diagram of a portion of a global flow chart of the implementation of the system;

FIG. 6C illustrates another isolated schematic diagram of a portion of a global flow chart of the implementation of the system;

FIGS. 7a and 7b illustrate a transaction schematic diagram of the system;

FIG. 8 illustrates a snapshot of the system;

FIG. 9 illustrates another perspective view of the system;

FIG. 10 illustrates another perspective view of the system;

FIG. 11 illustrates another perspective view of the system;

FIG. 12 illustrates another perspective view of the system;

FIG. 13A illustrates another perspective view of the system;

FIG. 13B illustrates another perspective view of the system;

FIG. 14 illustrates another perspective view of the system;

FIG. 15 illustrates another perspective view of the system; and

FIG. 16 illustrates another perspective view of the system.

### DETAILED DESCRIPTION OF THE EMBODIMENTS

With reference to the Figures, a property interactive system 1 according to the invention is shown.

In the exemplary embodiment, the property interactive system 1 generally includes an application site. One of ordinary skill in the art would understand the applicant's design is not the exclusive embodiment. In the exemplary embodiment, the application site is designed to work on internet Explorer 10+, and the most up-to-date versions of Chrome, Safari and Firefox across all major operating systems and updated device platforms for example Android and IOS. One of ordinary skill in the art would understand the applicant's design is not the exclusive embodiment.

Hardware infrastructure for an embodiment of the property interactive system 1 will be described. In an exemplary embodiment, the property interactive system 1 is built on a network router (for instance, a wireless router) and connected to a database server, while also utilizing known hardware components, including a web server, a firewall, a network, and the computing device.

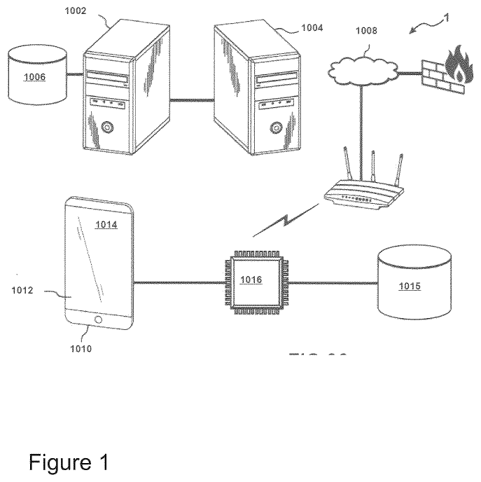

Referring first to FIG. 1, which is a broad overview of the hardware infrastructure for an embodiment of the property interactive system 1 will be described. To perform the aforementioned and other functions, the property interactive system 1 generally includes a plurality of integrated system servers 1002, 1004 with one or more databases 1006 (i.e., internal information repository), a network interface 1008 accessible through various known communication protocols, such as TCP/IP, cellular protocols including GSM, Wi-Fi, Wi-Max, or other wireless communications technologies or combination of wired or wireless channels, network security devices (where necessary), and a computing device 1010 having a processing unit 1016 and memory 1015.

The property interactive system 1 allows a user to access a plurality of system files that includes data, such as information and images, through the computing device 1010 and a network traffic information on the database server 1002 (i.e. SQLServer or PostgreSQL (also known as Postgres) or newer) that connects to a web server 1004. The web server 1004 functions as a way for network interface 1008 to communicate to the database server 1002 through known application-programming interface (API) between the computing device 1010 and the database server 1002. A firewall may be used for security purposes such as, but is not limited to, blocking unauthorized access to the web server 1004 and permitting unauthorized communication thereto. The property interactive system 1 is designed to run through the computing device 1010 through a property interactive module that can be downloaded over personal area networks (PANs), local area networks (LANs), campus area networks (CANs), wide area networks (WANs), metropolitan area networks (MANs) and any new networking system developed in the future. One skilled in the art should appreciate that the property interactive system 1 can be maintained solely through the computing device 1010, as the property interactive system modules can be pre-loaded to the computing device 1010.

The computing device 1010 as depicted having a processor 1016 for performing the necessary calculations and performing the actions for the property interactive system module having a plurality of service modules within the property builder module, and also having memory 1015, configured for storing and accessing the property interactive system files, including a plurality of buyer user functions, a plurality of seller user functions, a plurality of attorney functions which may be employed in the property interactive simulation. In the shown embodiment, the user may connect to the network interface 1008 using the computing device 1010 through the router for instance. One skilled in the art would appreciate that other hardware and protocol designs are possible as long as such modifications would not divert from the spirit of the invention.

In an exemplary embodiment, as shown in FIG. 1, the computing device 1010 generally includes the general user interface 1014, the memory device 1015, and the processor 1016. In the shown embodiment, the computing device is a tablet computer or mobile phone with a touchscreen display 1012. The touchscreen display 1012 uses finger or stylus gestures to navigate the general user interface (GUI) 1014. However, one skilled in the art should appreciate that other implements could be used; including a computer mouse, a keyboard, or joystick. In fact, one skilled in the art should appreciate that the computing device 1010 is a physical computer and could be, but not limited to, a desktop computer, a laptop computer, or a cell phone, and utilize a downloaded application or web browser. The memory device 1015 is a storage device having computer components and recording media used to retain digital data. The processor 1016 is a central processing unit (CPU) that manipulates data stored in the memory device 1015 by performing computations.

In the exemplary embodiment, the property interactive system files, including the seller user functions, the buyer user functions, the approved agent functions and the developer user functions, and programming language necessary for performing the simulation may be loaded into the memory device 1015 of the computing device 1010, and performable by the processor 1016, utilizing user inputs through the general user interface 1014. In such an embodiment, there may be no need for communication through the network interface 1008 to communicate with external devices (e.g. servers 2, 4) through a network router.

In another exemplary embodiment, the property interactive system 1 includes and begins within the NestJS application, which instructs Puppeteer to navigate to specified public database websites. A Bull Queue manages and sequences jobs for retrieving information from multiple public databases. Puppeteer simulates browser actions to search for, retrieve, and download the required information and PDF documents. Once the PDF documents are downloaded, the NestJS application uploads these documents to AWS S3. Concurrently with PDF storage, the information retrieved by Puppeteer (excluding the content of PDFs) is formatted and stored in a database. For PDF documents requiring text extraction, AWS Textract is triggered by AWS Lambda to analyze the documents for text and data, extracting information from forms and tables within the PDFs. With all data gathered and processed—both the directly retrieved information stored in the database and the text extracted from PDFs by AWS Textract—the NestJS application proceeds to compile this information into a comprehensive report. The whole service is protected by authentication with JWT. When a request is made (either by a user or an administrator), the NestJS application validates the JWT provided with the request.

In the exemplary embodiment, the NestJS serves as the core back-end framework for the property interactive system 1. The NestJS is a progressive Node.js framework for building efficient, reliable, scalable server-side applications. The NestJS orchestrates the overall process flow, from initiating web scraping with Puppeteer to handling the database interactions and integrating with AWS services for PDF storage and processing.

The NestJS communicates with Puppeteer for data retrieval, interfaces with the database for data storage, interacts with AWS Lambda and AWS S3 for PDF management, and uses AWS Textract for optical character recognition (“OCR”).

In the exemplary embodiment, the Puppeteer automates browser actions for scraping information and downloading PDF documents from public databases. The Puppeteer is operated by functions initiated from the NestJS application. Additionally, the Puppeteer interacts with web pages, extracts data, and downloads PDFs.

In the exemplary embodiment, the database (Postgre) stores retrieved information for persistent access and manipulation. Moreover, the database receives and stores data from the NestJS application, retrieved and processed through Puppeteer. Additionally, the database receives and stores data from AWS Textract.

In the exemplary embodiment, the AWS S3le stores PDF documents retrieved from public databases. Additionally, the AWS S3le receives PDF files from AWS Lambda for storage and makes these files accessible for further processing by AWS Textract.

In the exemplary embodiment, the AWS Lambda manages the automated file processing of PDF documents from AWS S3 to AWS Textract. The AWS Lambda is triggered by AWS S3 events and to initiate AWS Textract processing.

In the exemplary embodiment, the AWS Textract performs the Optical Character Recognition (OCR) on PDF documents to extract text. The process PDF documents by the AWS Textract will be stored in AWS S3, with the results stored in the database.

In the exemplary embodiment, the report compilation integrates and formats the collected information into a coherent report while utilizing data from the database, including text extracted by AWS Textract, to generate reports 8.

In the exemplary embodiment, the Bull Queue schedules and executes background jobs. The Bull Queue further manages dependencies between tasks, ensuring that jobs are executed in the correct sequence. Moreover, the Bull Queue manages and sequences jobs for retrieving information from multiple public databases.

In the exemplary embodiment, the JWTs serve as a secure way to authenticate users. When a request is made (either by a user or an administrator), the NestJS application validates the JWT provided with the request. Essentially, the JWTs identifies if a user has permission to access the property interactive system 1.

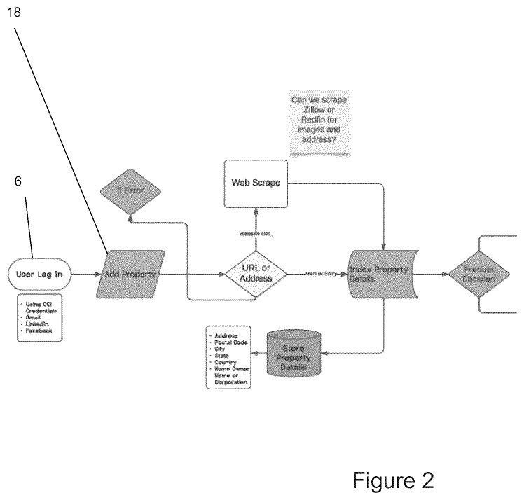

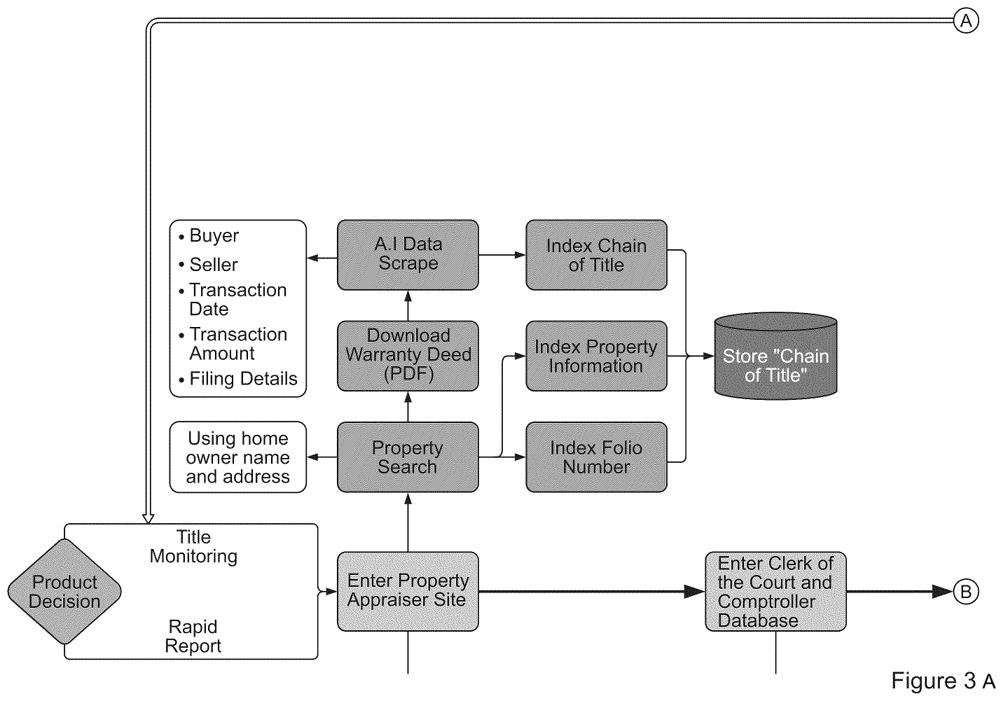

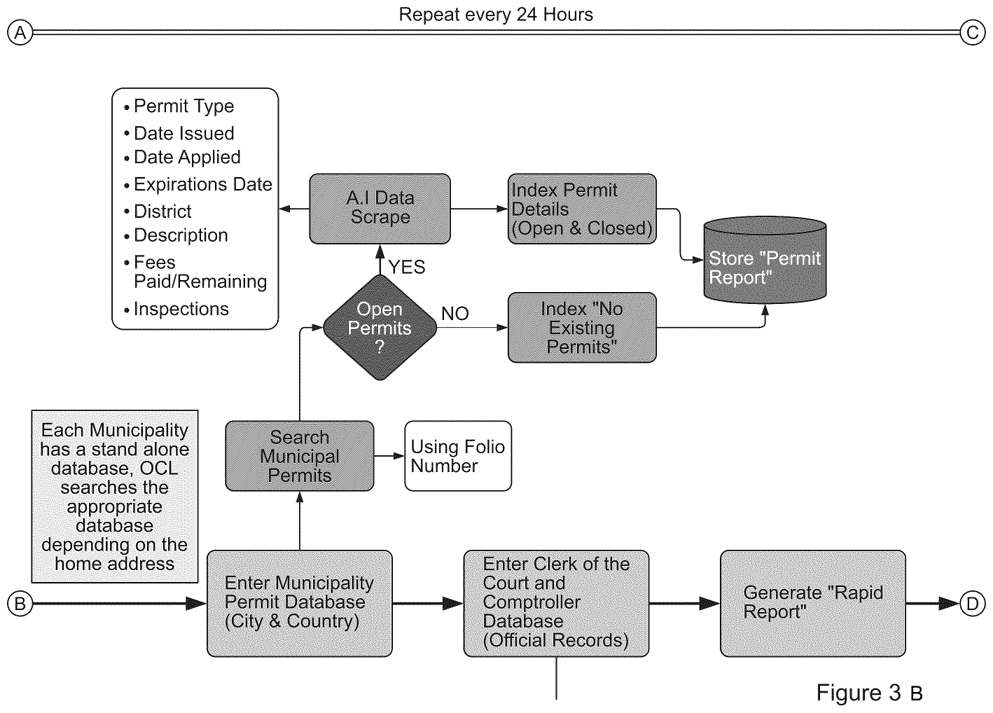

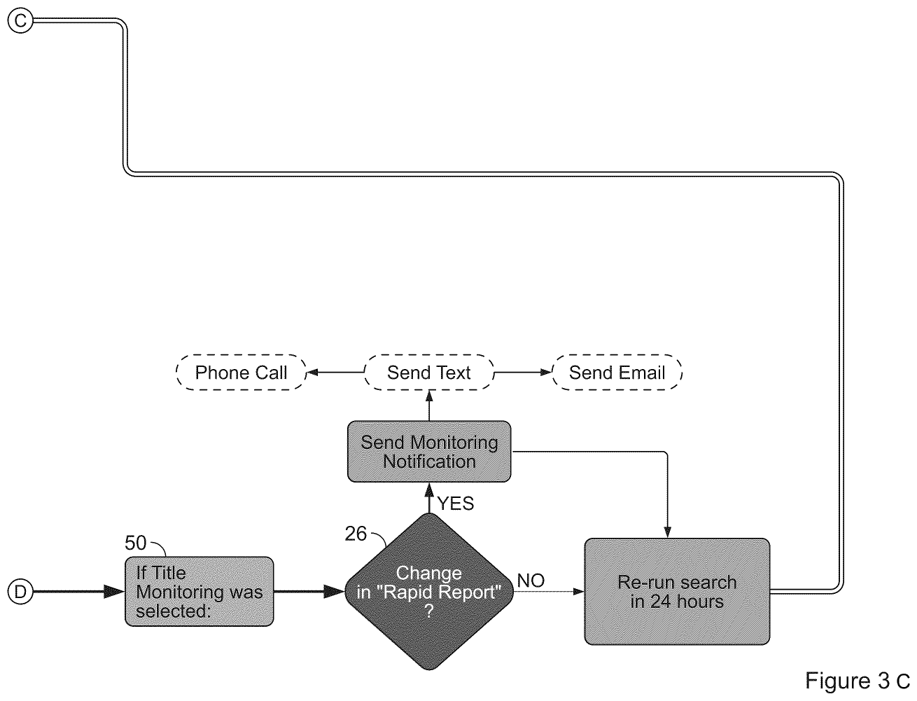

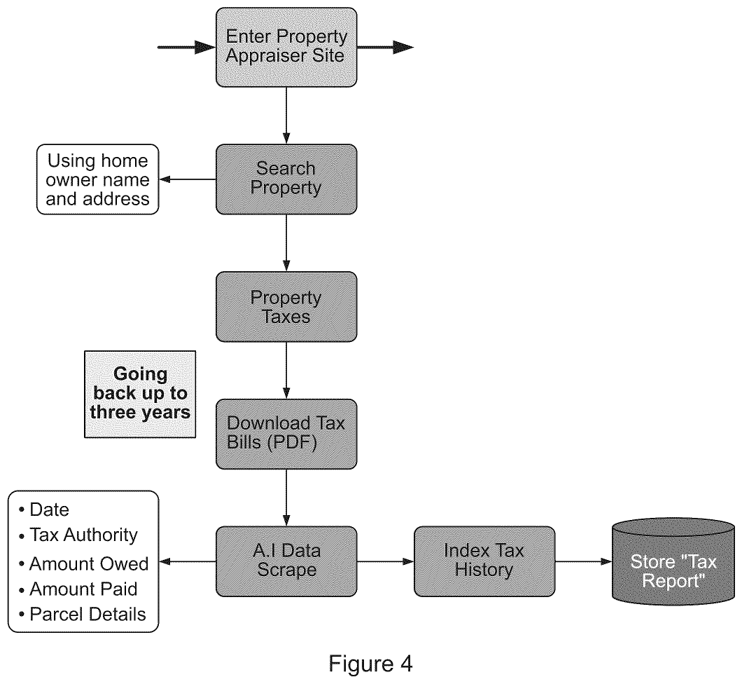

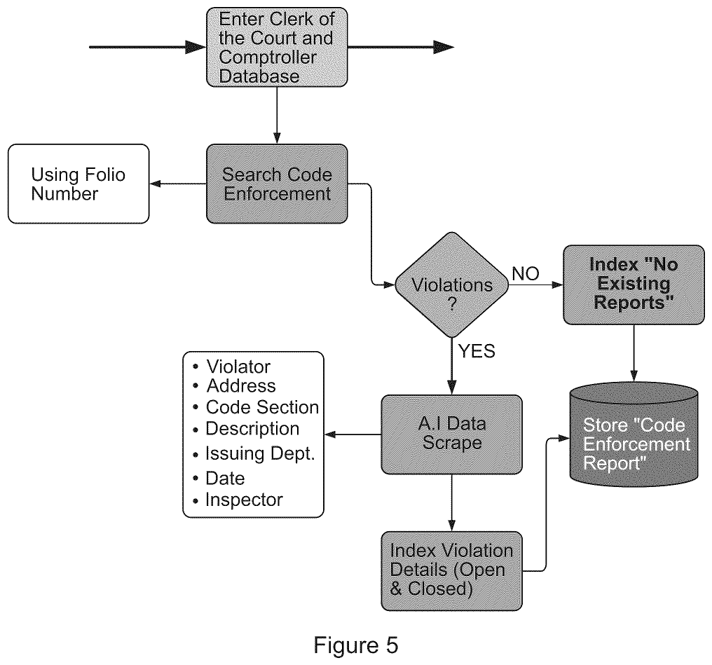

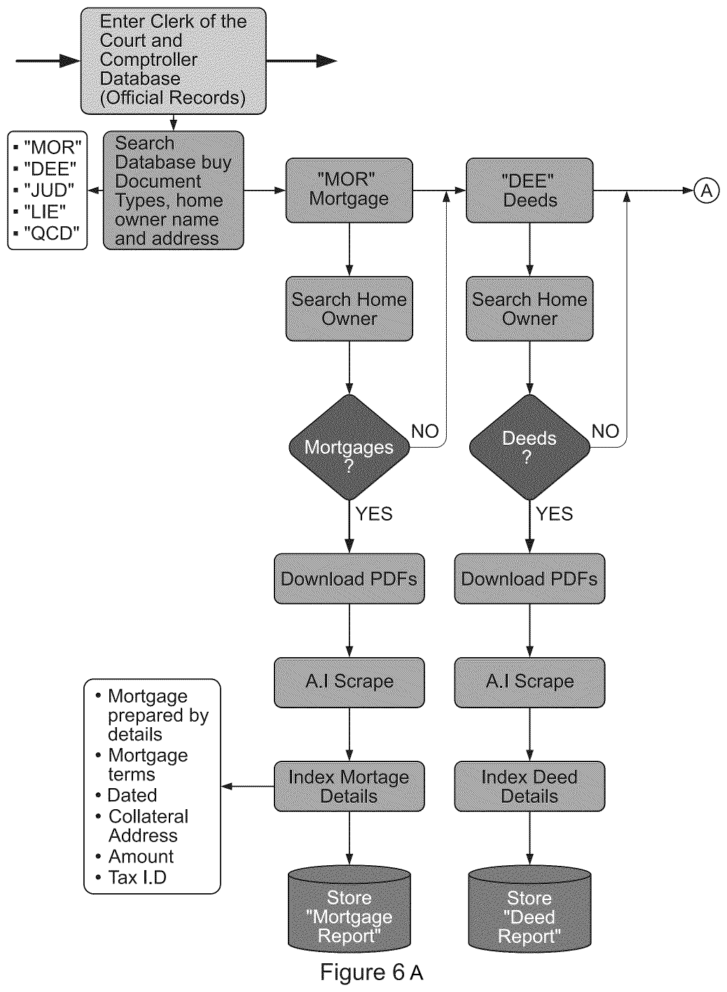

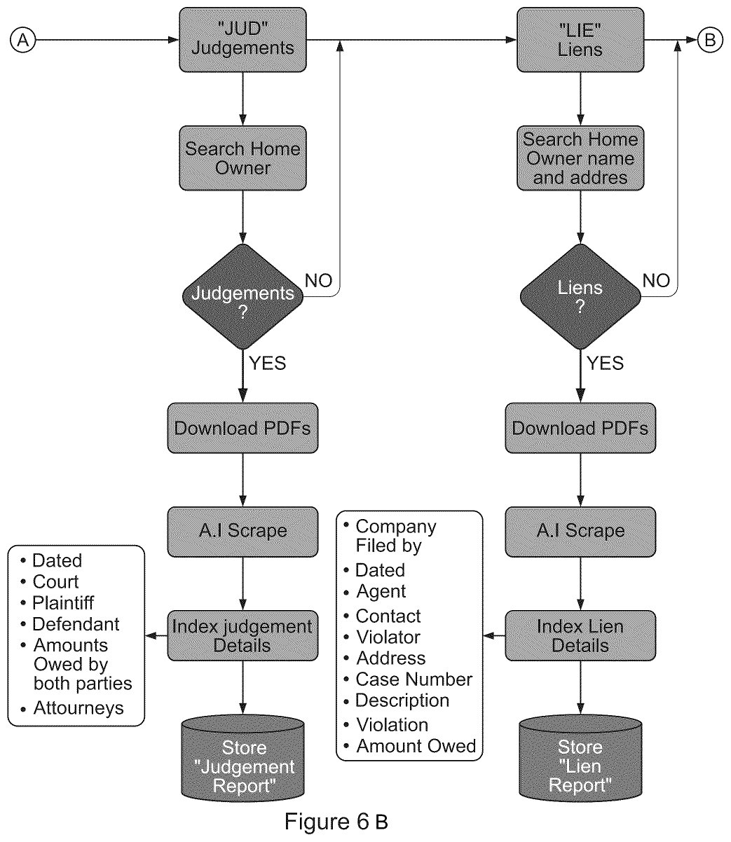

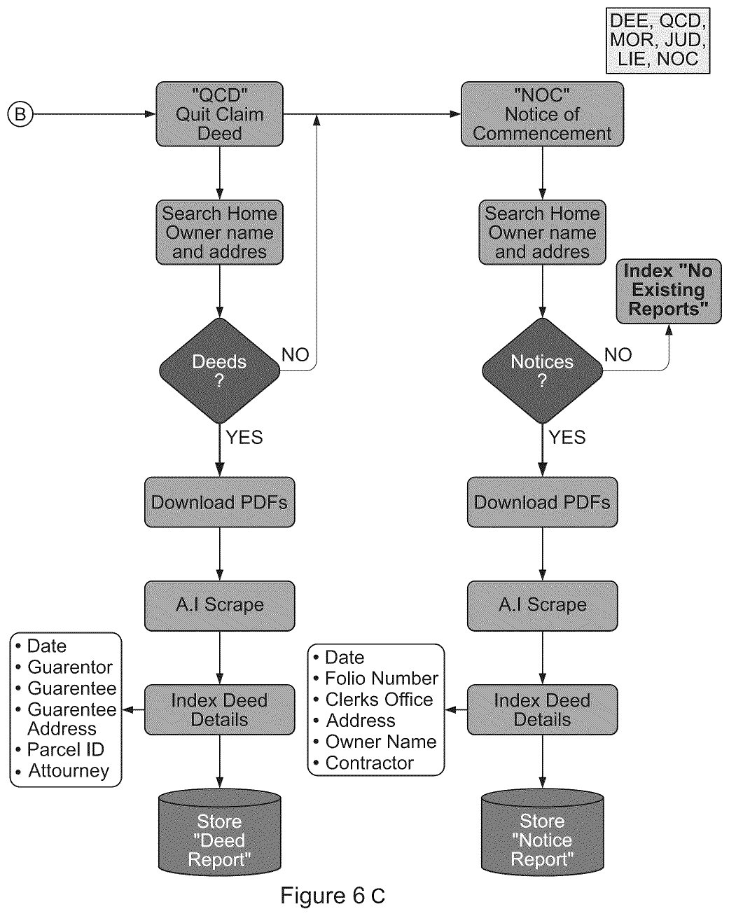

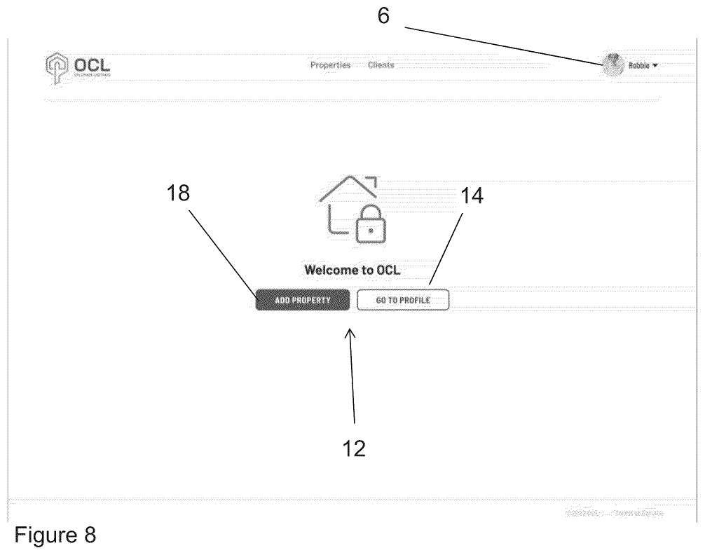

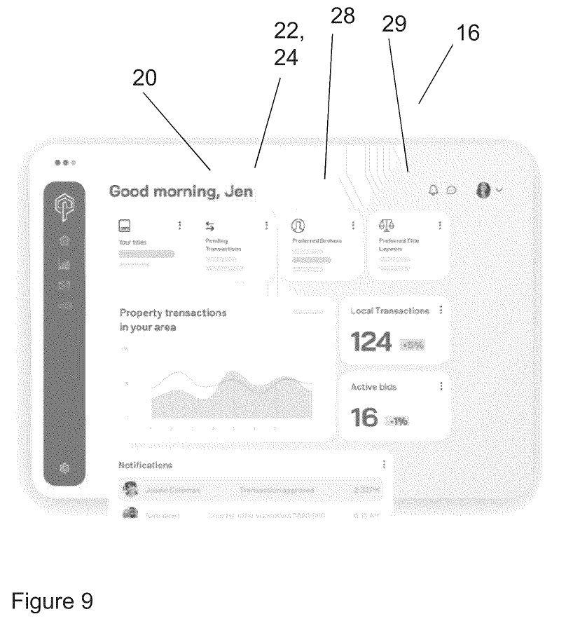

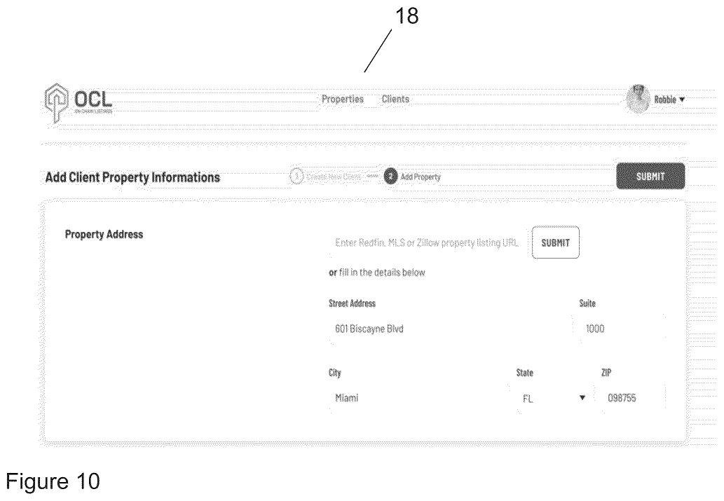

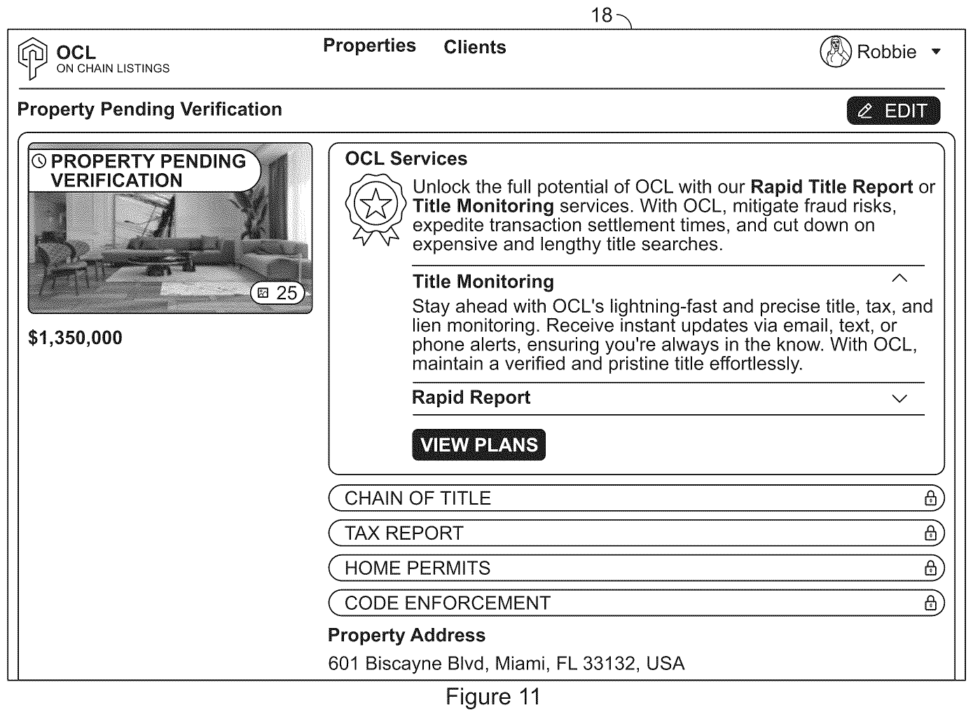

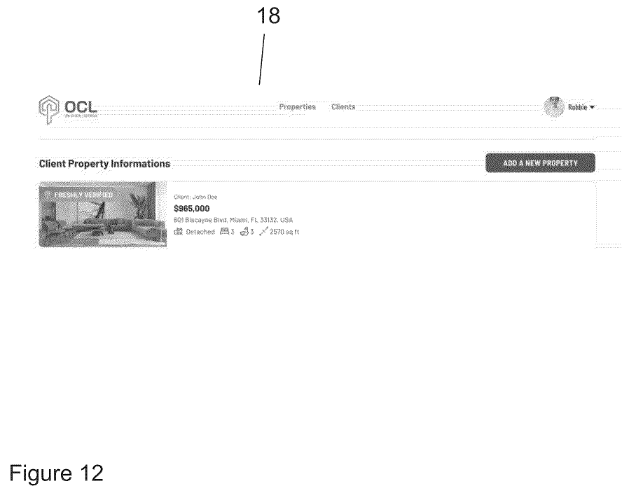

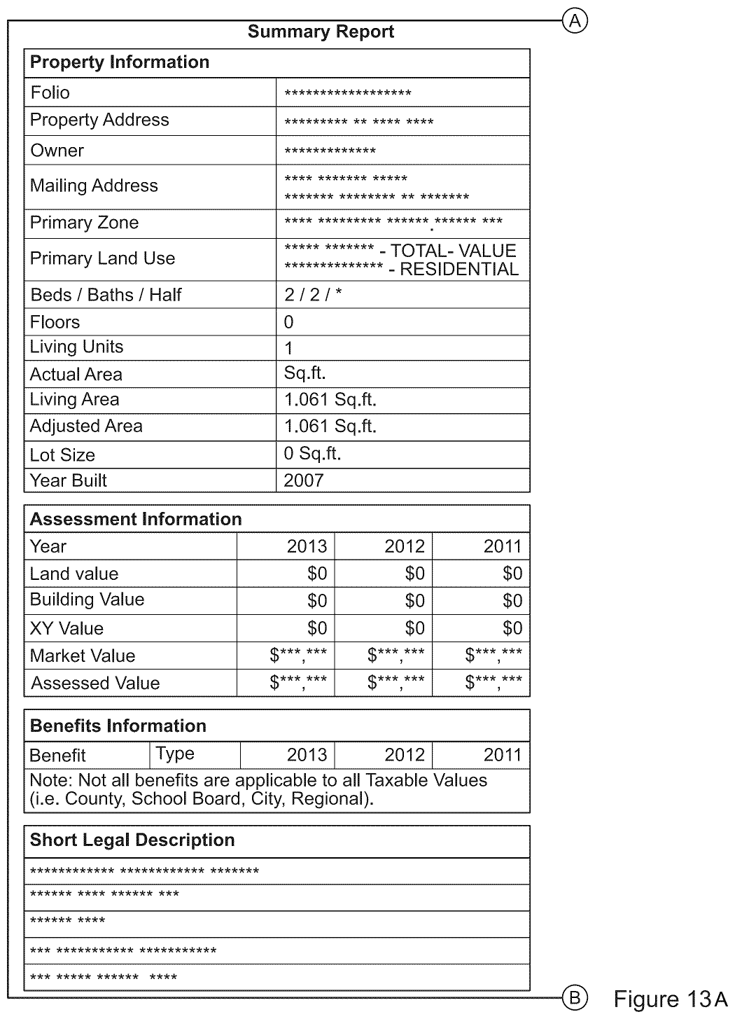

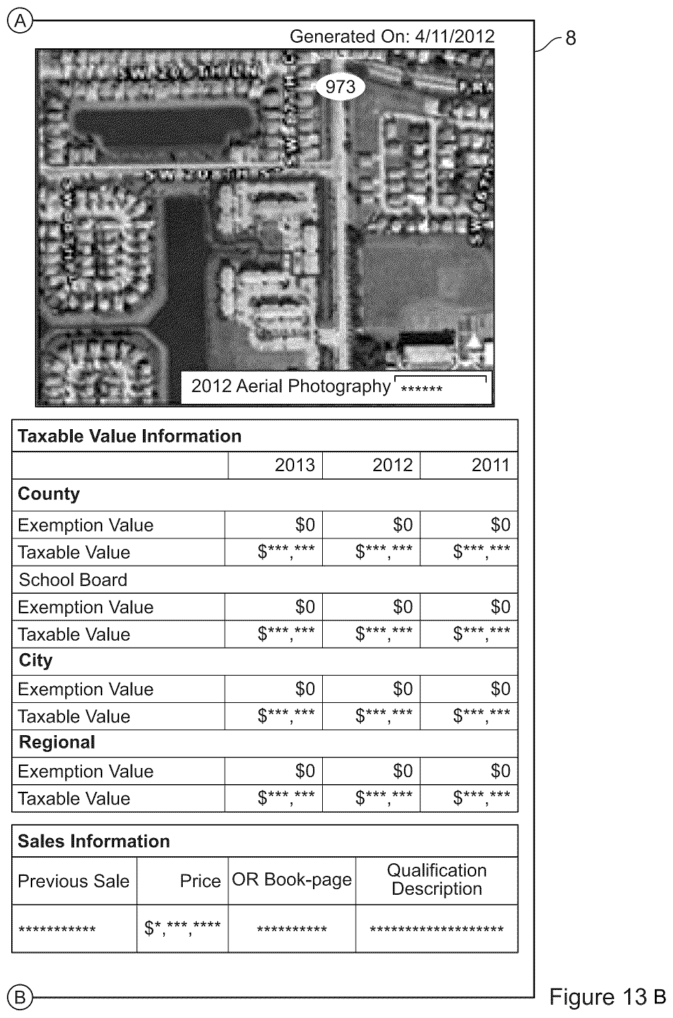

In the exemplary and as shown in FIGS. 2-16, a diagram is presented of the interactions of the property interactive system 1.

In the exemplary embodiment, the property interactive system 1 provides an exemplary set of templates and tools for use by the property seller 2 to identify and organize property listings elements such as copy, dates and digital files into coherent groupings for subsequent entry.

In the exemplary embodiment, the property interactive system 1 includes a plurality of property seller user functions. The plurality of property seller user functions includes a plurality of seller modules 12.

The property seller module 12 includes a property seller page module 14 accessible by a login 6 through the either an independent web application or phone application. In another exemplary embodiment, the property seller page module 14 may be accessible through a known brokerage website. The property seller page module 14 is an icon represented on a main page 16 of a seller user's account. The property seller page module 14 permits the seller 2 to access the plurality of seller modules 12 on a seller main page 16.

The plurality of seller modules 12 include an add property module 18 and a review property module.

The add property module 18 provides the seller 2 the ability to input important information regarding the property the seller wishes to list for potential purchasers. For example, this information may include address, property characteristics, price, sales terms, tax information, and (in most cases) pictures. One skilled in the art would understand the applicant's design is not the exclusive embodiment.

The review property module 20 provides the seller 2 to inspect pending buyer offers. The review property module 20 further includes an approve or deny buyer offer module. The approve buyer offer module 22 provides the seller to accept the offer. The deny buyer offer module 24 provides the seller to deny the offer. One skilled in the art would understand the applicant's design is not the exclusive embodiment.

The plurality of seller modules 12 further include a rapid report module 26 which will be described below.

In the exemplary embodiment, the plurality of seller modules 12 further includes an add real estate agent module 28.

In the exemplary embodiment, the plurality of seller modules 12 further includes an add title lawyer module 29.

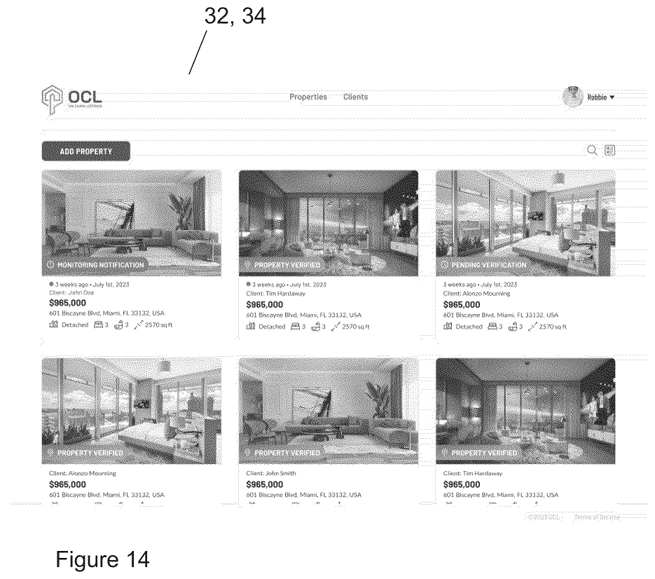

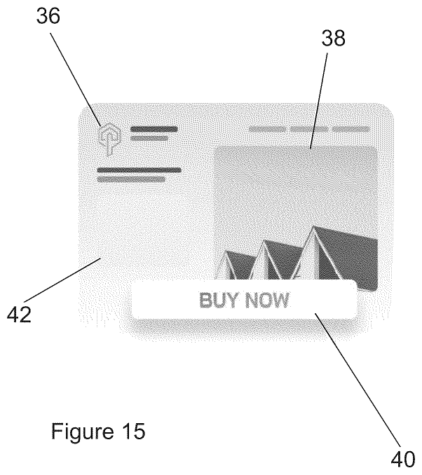

In the exemplary embodiment and as shown in FIGS. 14-15, the property interactive system 1 includes a plurality of buyer user functions. The buyer 4 using the property interactive system 1 includes plurality of property buyer user functions include a plurality of buyer modules 32.

The property buyer module 32 includes a property buyer page module 34 accessible by login similar to the property seller page module 14. The property buyer page module 34 is an icon represented on a main page 36 of a buyer user's account. The property buyer page module 34 permits the buyer 4 to access a plurality of buyer modules 32 on a buyer main page 36.

The plurality of buyer modules 32 includes a view property module 38 and a review pending offer module 42.

The view property module 38 provides the buyer 4 to view important information regarding the specific property provided by the seller 2. One skilled in the art would understand the applicant's design is not the exclusive embodiment. The view property module 38 further includes a buy now module 40 permitting a buyer 4 to enter an offer for the specific property.

The review property module 42 provides the buyer to review pending offers to the seller. The review property module 42 further provides indication if an offer is approved or denied by the seller.

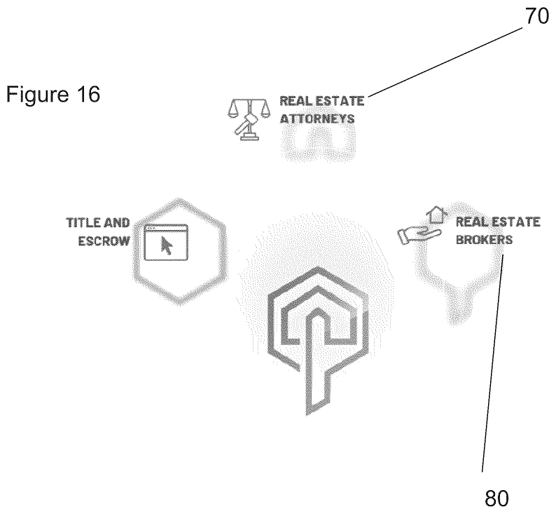

In the exemplary embodiment and as shown in FIG. 16, a title lawyer module 70 and a real estate agent module 80. The seller 2 will be permitted to choose a title lawyer and real estate agent through the add real estate module 28 and the add title lawyer module 29. The buyer is provided similar abilities.

In the exemplary embodiment, the chosen title lawyer and real estate agent will utilize the title lawyer module 70 and the real estate agent module 80 permitting the title lawyer and the real estate agent a multi-signatory system to authenticate, document, and verify property & title transfers on-chain in return for a processing fee, similar to a proof of work protocol.

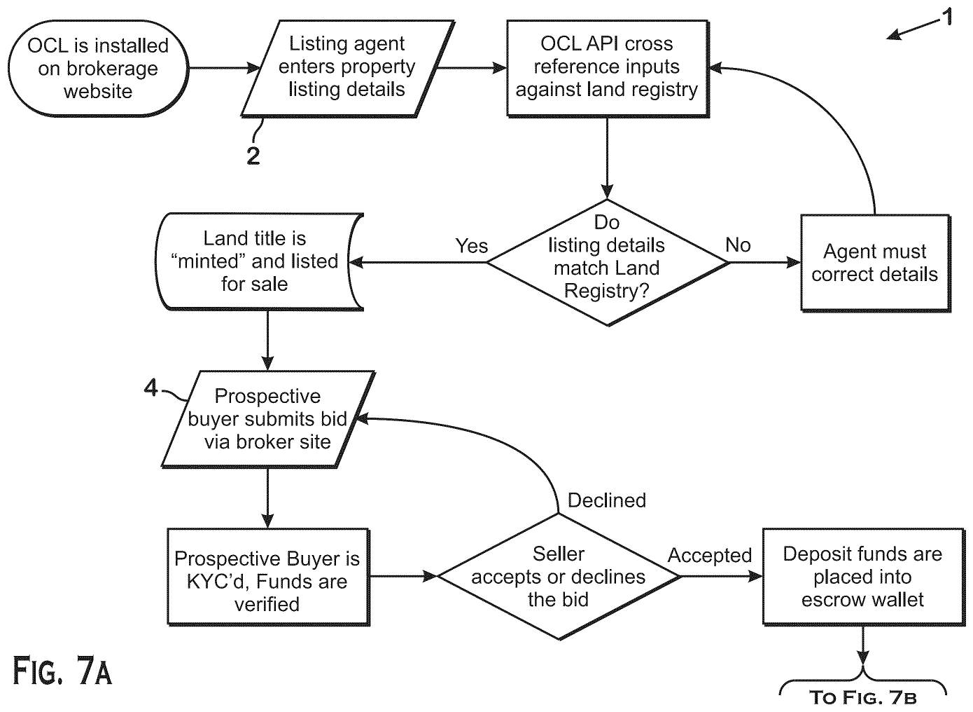

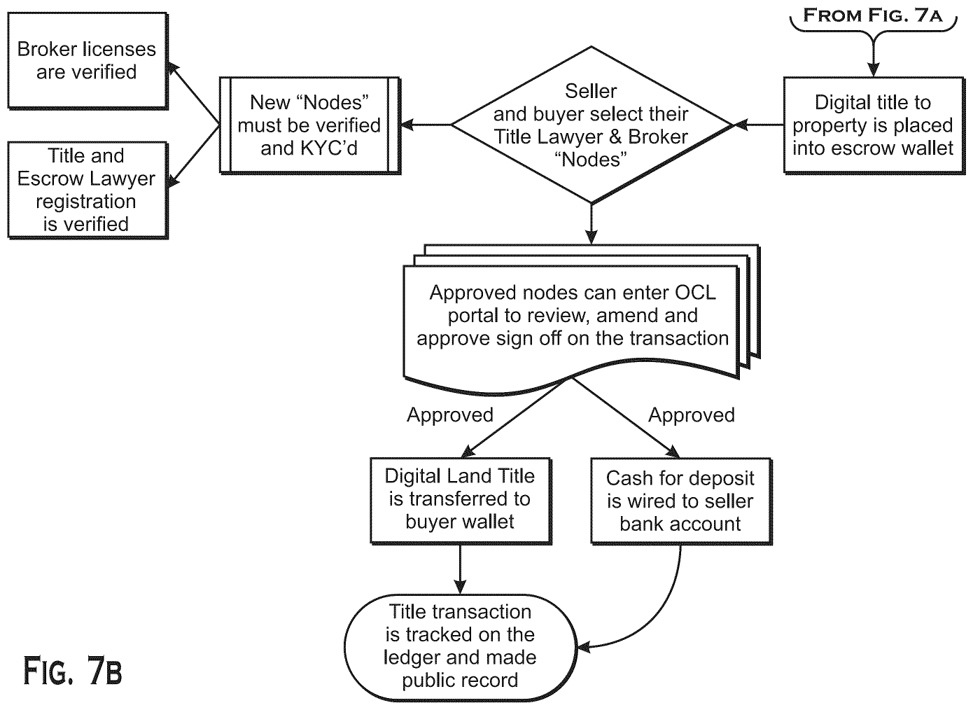

In the exemplary embodiment and as shown in FIGS. 7a-16, the property interactive system 1 is presented and accessible through an independent web application or phone application.

In the exemplary embodiment, the property interactive system 1 will be activated by the property seller 2 entering the property information in the add property module 18. The property seller 2 may also simply input a URL from a known brokerage site such as Zillow, Redfin, and MLS where the property interactive system 1 communicates with the brokerage site. The property interactive system 1 takes the URL associated with the listing from the external site and uses the address, postal code, and listing details to source, verify, and document a complete title report 8. Essentially, the property interactive system 1 takes the listing URL, and extracts and indexes the address and listing details. Using the listing details, the property interactive system 1 runs a data scrape across various government and municipality databases to source and amalgamate the Rapid Report 26, this includes data such as: Chain of Title. Tax Filings Code Violations, Permits, Mortgages, Liens Quit Claim Deeds, Judgements, Notice of Commencement etc. One skilled in the art would understand the applicant's design is not the exclusive embodiment.

Additionally, the property interactive system 1 provides a title monitoring module 50. With this module, the property interactive system 1 conducts daily searches and promptly notifies homeowners of any changes to the title search via text, email, and phone calls. This ongoing monitoring ensures timely awareness of any modifications to the title, encompassing both new and existing filings spanning the last 20 years. These searches occur every 24 hours and only provides feedback notification if a change has occurred to the property filings of the seller 2.

The property interactive system 1 communicates with a plurality databases using A.I operated data scraping that searches the PDF documents and webpages for specific details associated with each report. This includes information such as: Names, Dates, Details on the parties who filed, Addresses, Tax ID Numbers, Emails, Phone Numbers, Dollar values for amounts owed, Interest Rates, Violations, Descriptions, Hearing dates, Attorney name, firm, and contact details Clerks office. One skilled in the art would understand the applicant's design is not the exclusive embodiment.

In the exemplary embodiment, and as noted above, the property interactive system 1 will run a cross reference of the information in the add property module 18 with a land registry module by accessing various public sources, depending on the jurisdiction, typically available through online databases containing scanned PDF documents. Sources such as the County Clerk of the Court and Comptroller, Property Appraiser Site, and County Clerk Code Enforcement are utilized. One skilled in the art would understand the sources utilized by the property interactive system 1 are not the exclusive embodiment.

Upon receiving a verified KYC'd customer's property address, the property interactive system 1 retrieves a chain of title directly from the Appraiser Database, facilitating the download of PDF reports for the Chain of Title and Warranty Deeds. Subsequently, the property interactive system 1 employs Artificial Intelligence and algorithms to extract pertinent information such as the homeowner's details, address, folio number, and transaction date from the Warranty Deed. Leveraging the obtained folio number, the property interactive system 1 conducts comprehensive searches encompassing property liens, codes, permits, additional homeowners, and mortgages. This allows the property interactive system 1 the verification of personal liens, court rulings, utility liens, quit claim deeds, and more, all associated with the verified homeowner's name present on the Warranty Deed. In instances where the property owner is a corporation, the property interactive system 1 further identifies and lists the shareholders of the entity within the title report.

When the property interactive system 1 verifies the inputs of the add property module 18, a title to the property will be “minted” into a blockchain-based smart contract. The property interactive system 1 mints by converting the verified property title data into a format suitable for blockchain storage. Specialized algorithms and protocols are utilized to ensure the integrity and security of the data during the minting process. Once minted, the smart contract becomes permanently recorded on the blockchain, providing users with secure and transparent access to their property deeds.

The property seller 2 can interact with the smart contracts through the system's platform, accessing their property title data securely using designated wallet addresses and private keys. The system provides user-friendly tools and resources for managing and verifying property deeds. Once the data has been verified and minted, the property seller 2, in addition to their “Agents” who are designated by the homeowner/seller will be allocated private keys to gain access to view the data.

In the exemplary embodiment, the blockchain-based smart contract creates an official digital copy of the land registry record and publishes the property for viewing by the property buyer 4.

In the exemplary embodiment, property buyers 4 will view the property on the view property module 38 by permitting the buyer 4 to log into a web-based brokerage site where they will be able to view listings that have been made available by the brokerage/seller. The property interactive system 1 will provide the buyer the availability for immediate purchase using an on-chain title and will show a “Buy Now” on the buy now module 40 of the view property module 38.

Once the buyer selects “Buy Now,” on the buy now module 40, the buyer will be prompted by a verification portal.

In the exemplary embodiment, the verification portal will require a full Know Your Customer (“KYC”) to be conducted in order to meet the standards of the local municipality of the property. The property interactive system 1 will verify the buyer as a KYC to the local municipality.

In the exemplary embodiment, the buyer 4 will be considered a “verified buyer”, once verified. The buyer 4 will proceed and submit their bid price, a deposit amount, financing details to be verified with a financial institution, and any closing terms the buyer wishes to make the bid contingent. One skilled in the art would understand the applicant's design is not the exclusive embodiment.

In the exemplary embodiment, the now verified buyer 4 will have the option to select their preferred title lawyer and real estate agent by adding a title lawyer and a real estate agent similar to what is utilized by the seller 2 in the add real estate agent module 28 and the add title lawyer module 29. The add real estate agent module 28 and the add title lawyer module 29 for both the seller 2 and the buyer 4 will include an approved list of individuals that are verified in the appropriate jurisdiction.

The buyer 4 will provide the chosen title lawyer and real estate agent access to the property interactive system if the chosen title lawyer and the real estate is already an approved agent by the property interactive system 1. One skilled in the art would understand the applicant's design is not the exclusive embodiment.

If the buyer 4 chooses to use a title lawyer and real estate agent that are not an approved agent, the property interactive system 1 will verify the license and registration of the title lawyer and the real estate agent through the appropriate channels of the respective associations.

In the exemplary embodiment, in order to be approved as an approved agent, real estate agents and lawyers will need to pass a KYC in addition to proving their registration status, to prove that they are currently regulated in the appropriate jurisdiction. Once approved, the approved title lawyer and the approved real estate agent will now have the ability to sign off on the transaction. The approved agent will access a portal to review and sign off on the title report, access to a portal to review and sign off on the purchase and sale agreement and access to a portal to review and sign off on the closing disclosure.

In the exemplary embodiment, the seller 2 will receive a notification of a proposed bid. The seller 2 will proceed to the property seller page module 14. The seller 2 will access the review property module 20 to inspect pending buyer offers.

The seller 2 will be able to accept or decline the proposed bid by the approved buyer offer module 22 and the deny buyer offer module 24.

In the exemplary embodiment, if the bid is accepted by the seller 2 then a notification will be sent to the approved title lawyer and the approved real estate agent for signatures.

Simultaneously, the digital title to the property and the deposit amount are held in an escrow wallet until all approvals are completed.

In the exemplary embodiment, the title lawyer module 70 and the real estate agent module 80 will enable and permit the title lawyer and the real estate agent a multi-signatory system to authenticate, document, and verify property & title transfers on-chain in return for a processing fee, similar to a proof of work protocol.

In the exemplary embodiment, with the sign-offs having been completed by all the parties approved agents, the title is now able to be exchanged for the deposit amount. Here, the digital title to the property will be sent to the buyer's native wallet which will be accessible via the property interactive system 1, revealing all the property details and ownership history. Simultaneously, the capital for the deposit amount will be wired over to the selling party ie seller 2.

The above description is only for the specific embodiment of the present invention and is not intended to limit the scope of the present invention. The equivalent changes or modifications made by the structures, features and principles of the present invention should be included in Within the scope of the patent application of the present invention.

What is claimed is:

1. A property interactive system comprising:
a plurality of seller user functions, the plurality of seller user functions having an add property module, the add property module displays seller added listings;
a review property module;
a plurality of buyer user functions, the plurality of buyer user functions having a buy now module, the buy now module provides the buyer the ability for immediate purchase of a listing using an on-chain title, the seller inspects pending buyer offers through the review property module to either accept the pending offer or deny the pending offer.

2. The property interactive system of claim 1, wherein the plurality of seller user functions includes a rapid report module.

3. The property interactive system of claim 2, wherein the plurality of buyer user functions includes a review pending offer module providing indication if an offer is approved or denied by the seller.

4. The property interactive system of claim 3, wherein the property interactive system further comprises a title lawyer module.

5. The property interactive system of claim 4, wherein the property interactive system further comprises a real estate agent module.

6. The property interactive system of claim 5, wherein the seller and the buyer will be permitted to a choose a title lawyer and a real estate agent through the property interactive system.

7. The property interactive system of claim 6, wherein the chosen title lawyer will access a multi-signatory system to authenticate, document, and verify property & title transfers on-chain.

8. The property interactive system of claim 7, wherein the chosen real estate agent will access a multi-signatory system to authenticate, document, and verify property & title transfers on-chain.

9. The property interactive system of claim 8, wherein the system extracts a URL of an associated listing and uses the address, postal code, and listing details to source, verify, and document a complete title report.

10. The property interactive system of claim 9, wherein the system further comprises a title monitoring module.

11. The property interactive system of claim 10, wherein the title monitoring module conducts daily searches and promptly notifies homeowners of any changes to the title search via text, email, and phone calls.

12. The property interactive system of claim 11, wherein the system will run a cross reference of the information in the add property module with a land registry module by accessing various public sources.

13. The property interactive system of claim 12, wherein the system verifies inputs of the add property module, a title to the property will be minted into a blockchain-based smart contract.

14. The property interactive system of claim 13, wherein the system will verify the buyer as a KYC to a local municipality.

15. The property interactive system of claim 14, wherein the system will verify an unapproved title lawyer prior to accessing the title lawyer module through KYC.

16. The property interactive system of claim 15, wherein the system will verify an unapproved real estate agent prior to accessing the real estate agent module through KYC.
